(19) United States
(12) Patent Application Publication
(10) Pub. No.: US 2020/0387841 A1
(43) Pub. Date: Dec. 10, 2020

(54) METHOD AND APPARATUS FOR GENERATING HOST LOCALIZED MEAL VOUCHERS IN A HOSPITALITY BOOKING SYSTEM

(71) Applicant: Monginis Foods Pvt Ltd, Mumbai (IN)

(72) Inventor: Qusai Zoher KHORAKIWALA, Mumbai (IN)

(21) Appl. No.: 16/432,992

(22) Filed: Jun. 6, 2019

(51) Int. Cl. G06Q 10/02; G06Q 50/12; G06Q 50/14

(52) U.S. Cl. CPC G06Q 10/025; G06Q 50/14; G06Q 50/12

(57) ABSTRACT

The present invention provides a system, method and an apparatus for the generation of host localized meal vouchers for booking users in a hospitality booking system. The system comprises of a set of databases i.e. user database, food vendor database and a shared hospitality space database; a set of modules i.e. a host localized meal voucher module, an accommodation booking module, a meal voucher generator, a purchase module, a food vendor location module, a maps module and an authorization module. With this invention, the booking user can generate and redeem a subset of host localized meal vouchers for a preset period of time from multiple hyperlocal food providers near a shared hospitality space booked using a hospitality booking system.

### BACKGROUND OF THE INVENTION

The current online hospitality and food booking system environment includes members like ordering users, receiving users, food vendors, and hospitality service providers. Many online hospitality and food booking systems, online food ordering mobile applications and online hospitality booking mobile applications allow users to select rooms or shared hospitality spaces based on the location of the user and selected destination and to get the booking confirmed at the desired location. Recently, online hospitality booking system providers enable users to book holiday or travel packages including food and beverages along with the travel and stay bookings via a computer or mobile interface.

However, online hospitality and food booking systems, especially those offering online hospitality and food booking through mobile applications may disable generation of locally restricted and previously listed meal vouchers to specific users from a variety of local food providers and restaurants at the planned destination of the ordering users. The reason for denial of localized service offerings may be partly due to the fact that the current online hospitality and food booking system environment and associated computer-implemented method or computer implemented interface adaptations disable booking users to conduct hyperlocal ordering of food or outside dining at the destination of the booking user, for food items or dining bookings delivered by third parties like third party restaurants, food providers and other food establishments valid up-till the stay of the booking users at the destination

Currently, there are systems that enable users to search for restaurants unilaterally and individually in the vicinity of the property where the stay is booked and make payments as per the menu cards at the restaurants.

A user is restricted from generating and redeeming meal vouchers on a hospitality booking system for shared hospitality spaces, wherein upon booking a stay at a property listed on such a marketplace or hospitality booking system, the user may redeem the meal vouchers at the affiliated restaurants in the vicinity or in a predefined radius of neighborhood location for a predefined period of time not exceeding the duration of their stay at the destination and the specific shared hospitality space.

### SUMMARY OF THE INVENTION

The present invention specifically relates to the generation of host localized meal vouchers for booking users in a hospitality booking system.

Another aspect of the present invention is pre-approval of meal vouchers by multiple food vendors in association with the shared hospitality spaces and a unique identification code for each meal voucher.

Another aspect of the invention is timed disablement to the meal vouchers on dates do not correspond to the booked dates of the shared hospitality space.

Yet another aspect of the invention is timed disablement s to the meal vouchers when not redeemed for delivery of food items or for dine-in.

Other objects and advantages of the present invention will become apparent from the following description taken in connection with the accompanying drawings, wherein, by way of illustration and example, the aspects of the present invention are disclosed.

### BRIEF DESCRIPTION OF THE DRAWINGS

The disclosed embodiments have other advantages and features which will be more readily apparent from the detailed description, the appended claims, and the accompanying figures (or drawings). A brief introduction of the figures is below.

FIG. 1 is a functional block diagram of a hospitality booking system 100 according to one embodiment.

FIG. 2 is a block diagram of a host localized meal voucher module 110 according to one embodiment.

FIG. 3 is a flow diagram of the method for the generation of host localized meal vouchers for booking users in a hospitality booking system according to one embodiment.

FIG. 4 illustrates modules of an example machine 400 able to read instructions from a machine-readable medium and execute them in a processor (or controller) according to one embodiment according to one embodiment.

### DETAILED DESCRIPTION OF THE INVENTION

The following description describes various features and functions of the disclosed method and apparatus with reference to the accompanying figures. In the figures, similar symbols identify similar components, unless context dictates otherwise. The illustrative aspects described herein are not meant to be limiting.

These and other features and advantages of the present invention may be incorporated into certain embodiments of the invention and will become more fully apparent from the following description and claims or may be learned by the practice of the invention as set forth hereinafter. It may be readily understood that certain aspects of the disclosed system, method and apparatus can be arranged and combined in a wide variety of different configurations, all of which are contemplated herein.

Accordingly, those of ordinary skill in the art will recognize that various changes and modifications of the embodiments described herein can be made without departing from the scope of the invention. In addition, descriptions of well-known functions and constructions are omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention are provided for illustration purpose only and not for the purpose of limiting the invention.

It is to be understood that the singular forms “a,” “an,” and “the” include plural referents unless the context clearly dictates otherwise.

It should be emphasized that the term “comprises/comprising” when used in this specification is taken to specify the presence of stated features, integers, steps or components but does not preclude the presence or addition of one or more other features, integers, steps, components or groups thereof.

The Figures (FIGS.) and the following description relate to embodiments by way of illustration only. It should be noted that from the following discussion, alternative embodiments of the systems, methods, figures, diagrams and interfaces disclosed herein will be readily recognized as viable alternatives that may be employed without departing from the principles and spirit of the invention.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the systems, methods, figures, diagrams and interfaces illustrated herein may be employed without departing from the principles described herein. In the following description, for the purposes of explanation, numerous specific details are set forth in order to provide a thorough understanding of the various embodiments. It will be evident, however to one skilled in the art that the various embodiments may be practiced without these specific details.

Configuration Overview

A system and method for the generation of host localized meal vouchers for booking users in a hospitality booking system is provided. The host localized meal voucher module in the hospitality booking system may comprise a plurality of modules and generators like a host localized meal voucher module, an accommodation booking module, a meal voucher generator, a purchase module, a food vendor location module, a maps module and an authorization module. The method for the generation of host localized meal vouchers for booking users in a hospitality booking system may comprise a plurality of steps like receiving a host localized meal voucher generation request from a booking user, determining the available host localized meal vouchers preauthorized by shared hospitality spaces, determining the geographical location of food vendors associated with subset of meal vouchers, and displaying the subset of the list of host localized meal vouchers to the booking user.

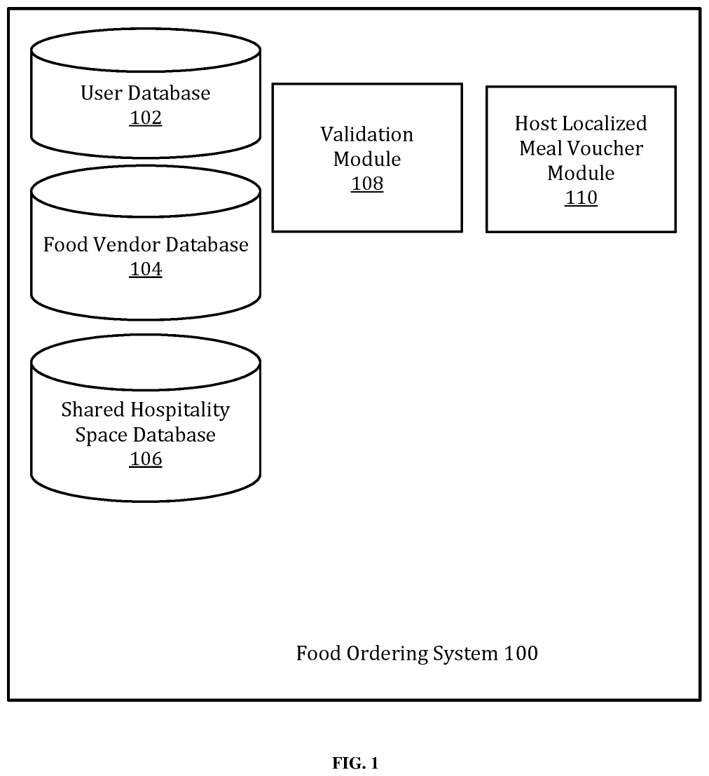

FIG. 1 is a functional block diagram of a hospitality booking system 100 according to one embodiment. The hospitality booking system 100 includes a plurality of databases and modules for generation of host localized meal vouchers for booking users in a hospitality booking system 100. The host localized meal vouchers are made available to users using the host localized meal voucher module. Additional modules of the hospitality booking system 100 are described below.

A user database 102 may maintain information about each type of user based on the user's role in the system. The user information may be stored in a plurality of databases, each database associated with a user role, or the user roles may be stored in a single user database 102. For example, the additional user roles include booking users, food item vending users, shared hospitality space listing users, and other types of users of the hospitality booking system 100.

The user database 102 is further configured for receiving, storing, updating and retrieving a plurality of data fields of each user, such as, but not limited to name, address, and contact details of corresponding user(s). Depending on the role of the user in the hospitality booking system 100, the user database 102 maintains additional information on the user such as, but not limited to booking history, details of the services availed during different stay durations in the hospitality booking system 100.

In one embodiment, a distinct food vendor database 104 is configured for receiving, storing, updating and retrieving a plurality of data fields of each food items from each vendor, comprising the name of the food vendor, location, special offers and discounts, active host localized meal vouchers and redemption criteria, delivery timings, preferences, food items, prices, associated shared hospitality spaces and/or criteria if any, along with payment mode.

In one embodiment, a shared hospitality space database 106 is configured for receiving, storing, updating and retrieving a plurality of data fields of each shared hospitality space, comprising the details of shared hospitality spaces offered by users of the hospitality booking system 100, price, availability, rent, location, reviews, associated food vendors and such other shared hospitality space criteria.

A validation module 108 is configured for validating the user credentials of the exemplary booking users of the hospitality booking system 100.

A host localized meal voucher module 110 is configured for the generation of host localized meal vouchers for booking users in a hospitality booking system. In some embodiments, the generation of host localized meal vouchers further comprises the pre-approval of meal vouchers by multiple food vendors in association with the shared hospitality spaces and a unique identification code for each meal voucher. In other embodiments, the access to host localized meal vouchers is denied on dates which do not correspond to the booked dates of the shared hospitality space or when not redeemed for delivery of food items or for dine-in.

In one embodiment, the user database 102, food vendor database 104, shared hospitality space database 106 and other databases form a single consolidated database in the hospitality booking system 100.

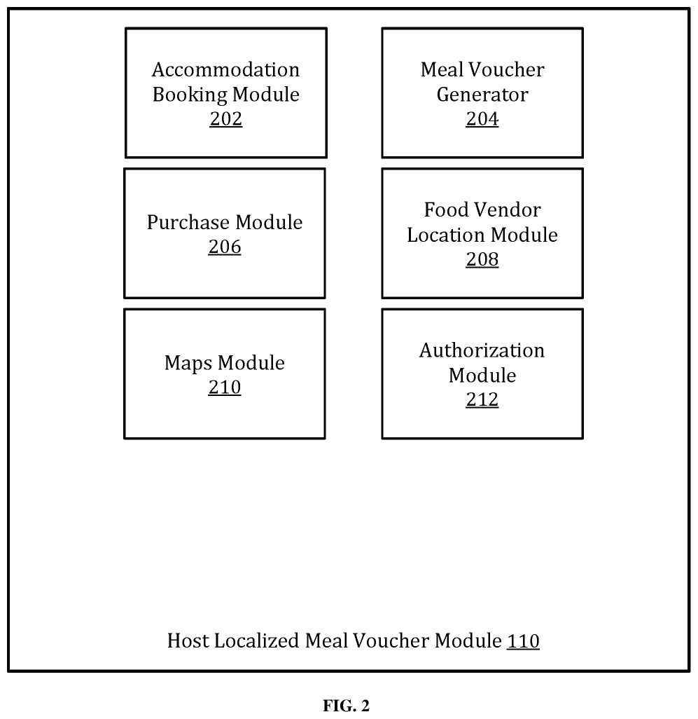

FIG. 2 is a block diagram of a host localized meal voucher module 110 according to one embodiment. The host localized meal voucher module 110 is configured for receiving, storing, retrieving and updating a plurality of host localized meal vouchers in the hospitality booking system 100. In some embodiments, the host localized meal vouchers may be accessed from a food vendor database 104.

The accommodation booking module 202 is configured for receiving, storing, retrieving and updating a plurality of accommodation booking requests and host localized meal voucher generation requests from exemplary booking users in the hospitality booking system 100.

The meal voucher generator 204 is configured for receiving, storing, retrieving and generating a plurality of host localized meal vouchers in the hospitality booking system 100.

The purchase module 206 is configured for receiving, storing, retrieving and generating a plurality of purchase transactions and unique identification codes for each host localized meal voucher in the hospitality booking system 100.

The food vendor location module 208 is configured for receiving, storing, retrieving and generating a plurality of geographical location of the food vendors associated with the list of generated meal vouchers in the hospitality booking system 100.

The maps module 210 is configured for receiving, storing, retrieving and updating a plurality of geographical maps in the hospitality booking system 100.

The authorization module 212 is configured for receiving, storing, retrieving and updating a plurality of authorization conditions in the hospitality booking system 100.

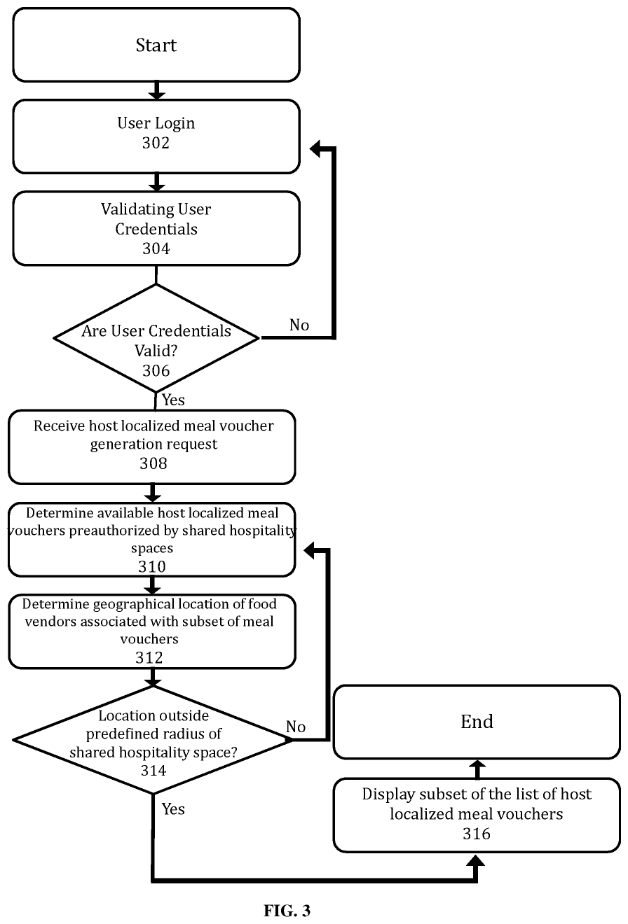

FIG. 3 is a flow diagram 300 of the method for the generation of host localized meal vouchers for booking users in a hospitality booking system 100 according to one embodiment. At step 302, an exemplary ordering user logs into the hospitality booking system using an associated electronic user device. At step 304, the user credentials of the exemplary ordering user are validated. At step 306, provided the user credentials are valid, the exemplary user is allowed access to the hospitality booking system 100. If the user credentials are not valid, the exemplary user is denied access to the hospitality booking system 100.

At step 308, the host localized meal voucher generation request is received via the accommodation booking module 202. At step 310, the available host localized meal vouchers are determined via the host localized meal voucher module 110, preauthorized by the shared hospitality spaces. At step 312, the geographical location of the food vendors associated with the host localized meal vouchers is determined via the food vendor location module 208. At step 314, the location of the food vendor is validated. At step 316, provided the food vendor associated with the host localized meal vouchers is within the predefined geographical radius of the shared hospitality space, the list of host localized meal vouchers is displayed via the host localized meal voucher module 110.

Although the hospitality booking system 100 is described as being composed of various components like databases and modules, the hospitality booking system 100 may comprise fewer or more databases, components, and other modules. For example, the hospitality booking system 100 may include a Voucher Redemption Module, a Voucher Expiry Module, or a Voucher Transfer Module with the present disclosure still falling within the scope of various embodiments. In some embodiments, an individual or group may play a plurality of user roles on the food ordering system, with the present disclosure still falling within the scope of various embodiments.

In various embodiments the hospitality booking system 100 may be any of a web application, a mobile application, or an embedded module or subsystem of an online food ordering environment, a mobile food ordering environment, a hospitality booking environment, a mobile travel booking environment, an electronic commerce system, an electronic payments system with the present disclosure still falling within the scope of various embodiments.

It is appreciated that, in some embodiments, a plurality of databases like 102, 104, 106, a plurality of modules 110, 202, 204, 206, 208, 210, 212, as well as the databases, engines, modules and components of the above embodiments may be stored in the form of machine readable instructions in the memory of the hospitality booking system 100 and executed by a processor of the hospitality booking system 100 to perform one or more embodiments disclosed herein. Alternatively, the plurality of s databases like 102, 104, 106, the plurality of modules 110, 202, 204, 206, 208, 210, 212 as well as the databases, engines, modules and components of the above embodiments may be implemented in the hospitality booking system 100 in the form of an apparatus configured to perform one or more embodiments disclosed herein.

The online food ordering and hospitality booking system includes a hospitality booking system 100 according to one embodiment. The hospitality booking system 100 operates in the online food ordering and hospitality booking system environment and communicates with a plurality of exemplary user devices over an exemplary network. The exemplary user devices are operated by a plurality of kinds of users in the online food ordering and hospitality booking system environment. The exemplary user devices may comprise any of a variety of computing devices, such as a desktop computer, a laptop, a mobile device, a tablet computer, a set-top box, a kiosk, interactive television, gaming console, and other computing platforms suitable for communicating with hospitality booking system 100. The hospitality booking system 100 provides a system for the generation of host localized meal vouchers in a hospitality booking system for a booking user. The hospitality booking system 100 enables the various users to communicate and transact with other users in an online food ordering and hospitality booking system environment and provide services to other users. The exemplary network includes a wireless area network, a local area network, a General Packet Radio Service (GPRS) network, an Enhanced Data for Global Evolution (EDGE) network and the like. The exemplary user devices are connected to the hospitality booking system 100 via an exemplary network.

Although the online food ordering and hospitality booking system environment described herein comprises of a plurality of user devices ( ) a communication network (, internet, intranet, world wide web), one skilled in the art may appreciate that number or kinds of users, user devices such that but not limited to cellular phones, laptops, tablets, personal computer, a portable gaming console device, a tablet device, a learning console device, gaming console device or server device attached to a television or other screen(s)) and the communication networks (internet, intranet, world wide web, an intranet at hospitality service providers, restaurants, fashion products ordering platforms, FMCG, groceries and essential products ordering platforms and local travel booking platforms) may also comprise the online food ordering and hospitality booking system, with the present disclosure still falling within the scope of various embodiments.

Computing Machine Architecture

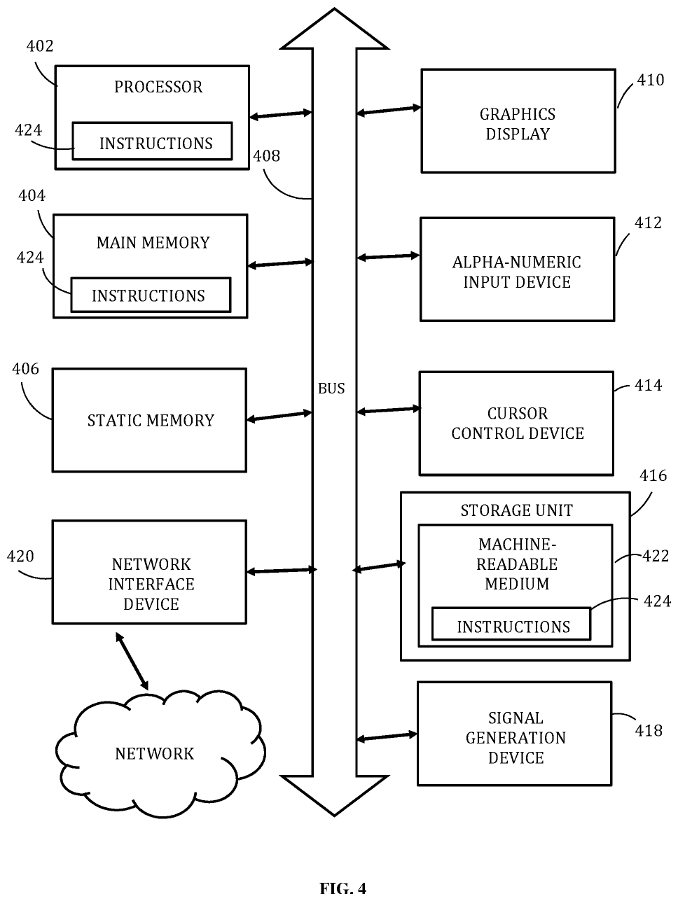

FIG. 4 is a block diagram illustrating modules of an example machine suitable for use as a hospitality booking system 100, for enablement of the embodiments disclosed herein performed, according to one embodiment. This example machine is able to read instructions from a machine-readable medium and execute them using a processor (or controller).

Specifically, FIG. 4 shows a diagrammatic representation of a machine in the example form of a computer system 400 within which instructions 424 (e.g., software) for controlling the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 424 (sequential or otherwise) that specify actions to be taken by that machine. Further, while only a single machine is illustrated, the term “machine” shall also be taken to include any collection of machines that individually or jointly execute instructions 424 to perform any one or more of the methodologies discussed herein.

The example computer system 400 which carries out the computer-implemented method includes a processor 402 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 404, and a static memory 406, which are configured to communicate with each other via a bus 408. The computer system 400 may further include a graphics display unit 410 (e.g., a plasma display panel (PDP), a liquid crystal display (LCD), a projector, or a cathode ray tube (CRT)). The computer system 400 may also include alphanumeric input device 412 (e.g., a keyboard), a cursor control device 414 (e.g., a mouse, a trackball, a joystick, a motion sensor, or other pointing instrument), a storage unit 416, a signal generation device 418 (e.g., a speaker), and a network interface device 420, which also are configured to communicate via the bus 408.

The storage unit 416 includes a machine readable medium 422 on which is stored instructions 424 (e.g., software) embodying any one or more of the methodologies or functions described herein. The instructions 424 (e.g., software) may also reside, completely or at least partially, within the main memory 404 or within the processor 402 (e.g., within a processor's cache memory) during execution thereof by the computer system 400, the main memory 404 and the processor 402 also constituting machine-readable media. The instructions 424 (e.g., software) may be transmitted or received over an exemplary network via the network interface device 420.

While machine readable medium 422 is shown in an example embodiment to be a single medium, the term “machine-readable medium” should be taken to include a single medium or multiple media (e.g., a centralized or distributed database, or associated caches and servers) able to store instructions (e.g., instructions 424). The term “machine-readable medium” shall also be taken to include any medium that is capable of storing instructions (e.g., instructions 424) for execution by the machine and that cause the machine to perform any one or more of the methodologies disclosed herein. The term “machine-readable medium” includes, but not be limited to, data repositories in the form of solid-state memories, optical media, and magnetic media.

The hospitality booking system 100 may be one or more servers in which one or more methods disclosed herein are performed. The processor 402 may be a microprocessor, a state machine, an Application Specific Integrated Circuit (ASIC), a Field Programmable Gate Array (FPGA), The main memory 404 may be a dynamic random access memory and/or a primary memory of the hospitality booking system 100. The static memory 406 may be a hard drive, a flash drive, and/or other memory information associated with the hospitality booking system 100.

The bus 408 may be an interconnection between various circuits and/or structures of the hospitality booking system 100. The video display 410 may provide graphical representation of information on the hospitality booking system 100. The alphanumeric input device 412 may be a keypad, keyboard, haptic touch, touch screens, push button actuators, turn knobs and/or any other input device. The cursor control device 414 may be a pointing device such as a mouse.

The storage unit 416 may be a hard drive, a storage system, and/or other longer term storage subsystem. The signal generation device 418 may be a Basic Input Output System (BIOS) and/or a functional operating system of the hospitality booking system 100. The network interface device 420 may be a device that may perform interface functions such as code conversion, protocol conversion and/or buffering required for communication to and from a network. The machine readable medium 422 may provide instructions 424 on which any of the methods disclosed herein may be performed. The instructions 424 may provide source code and/or data code to the processor 402 to enable any one/or more operations disclosed herein. For example, the hospitality booking system 100 may be stored in the form of instructions 424 on a storage medium such as the main memory 404 and/or the machine readable medium 422 such as compact disk.

In one embodiment, a non-transitory computer-readable storage medium having tangibly embodied thereon a program of instructions executable by a processor or a computing device (e.g., the hospitality booking system 100) causes the computing device to perform method steps illustrated in FIG. 3.

Additional Configuration Considerations

Throughout this specification, plural instances may implement modules, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate modules in example configurations may be implemented as a combined structure or module. Similarly, structures and functionality presented as a single module may be implemented as separate modules. These and other variations, modifications, additions, and improvements fall within the scope of the subject matter herein.

Certain embodiments described herein include functionality implemented in computing logic or a number of components, modules, or mechanisms, for example, as illustrated in FIGS. 1, 2, and 3. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a FPGA or an ASIC to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 402, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

In another embodiment, the host localized meal voucher interface provided by the hospitality booking system 100 may be accessed over a local area network, intranet or virtual private network accessible by a plurality of limited user devices of hospitality service providers, restaurants, fashion products ordering platforms, FMCG, groceries and essential products ordering platforms and local travel booking platforms.

In another embodiment, host localized meal voucher interface provided by the hospitality booking system 100 may be accessed over a wide area network, General Packet Radio Service network, an Enhanced Data for Global Evolution network, a 3G telecommunications network, a 4G LTE telecommunications network or other telecommunications network through a user device.

The performance of certain of the operations may be distributed among the one or more processors, not only residing within a single machine, but deployed across a number of machines. In some exemplary embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Although the present embodiments have been described with reference to specific example embodiments, it will be evident that various modifications and changes may be made to these embodiments without departing from the broader spirit and scope of the various embodiments. For example, the various devices, modules, databases, etc. described herein may be enabled and operated using hardware circuitry (e.g., complementary metal-oxide-semiconductor (CMOS) based logic circuitry), firmware, software and/or any combination of hardware, firmware, and/or software (e.g., embodied in a machine readable medium).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine modules that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B is true (or present).

In addition, use of the “a” or “an” are employed to describe elements and modules of the embodiments herein. This is done merely for convenience and to give a general sense of the invention. This description should be read to include one or at least one and the singular also includes the plural unless it is obvious that it is meant otherwise.

According to the embodiments described in FIG. 1 through 3, various methods and electric structures may be embodied using transistors, logic gates, and electrical circuits (For example, the host localized meal voucher module and other modules of FIGS. 1 to 3 may be enabled using a host localized meal voucher circuit and other circuits using one or more of the technologies described herein. In addition, it will be appreciated that the various operations, processes, and methods disclosed herein may be embodied in a machine-readable medium and/or a machine accessible medium compatible with a data processing system (e.g., a server) and may be performed in any order. Accordingly, the specification and drawings are to be regarded in an illustrative rather than a restrictive sense.

Upon reading this disclosure, those of skill in the art will appreciate still additional alternative structural and functional designs for a system and a method for the generation of host localized meal vouchers in a hospitality booking system through the disclosed principles herein. Thus, while particular embodiments and applications have been illustrated and described, it is to be understood that the disclosed embodiments are not limited to the precise construction and modules disclosed herein. Various modifications, changes and variations, which will be apparent to those, skilled in the art, may be made in the arrangement, operation and details of the method and apparatus disclosed herein without departing from the spirit and scope defined in the appended claims.

1. A method for generating host localized meal vouchers in a hospitality booking system, the system including one or more processors and a plurality of electronic user devices, the plurality of electronic user devices remotely linked over a computer network through a network interface device configured to communicaten to and from the computer network via a mobile or browser-based web application, a computer desktop application, an electronic module or subsystem of an online food ordering environment, a travel booking environment, a hotel reservation environment, a mobile environment, an electronic commerce system, an electronic payments system, a mobile application or an Internet-based website, each of the plurality of user computing devices including an electronic user interface and an electronic display, the one or more processors configured with one or more computer-implemented modules or generators including a meal voucher module, a validation module, an accommodation booking module, a meal voucher generator, a purchase module, a food vendor location module, a maps module, an authorization module, a user database, a food vendor database, a shared hospitality space database, the method comprising the steps of:
receiving, via the accommodation booking module, a host localized meal voucher generation request associated with a shared hospitality space booking request from an electronic device associated with at least one booking user, wherein the accommodation booking request comprises at least one date of accommodation, at least one check-in time, at least one check-out time and at least one geographical location;
determining, via the meal voucher module, a list of host localized available meal vouchers from a plurality of meal vouchers associated with the booked shared hospitality space, wherein the meal vouchers are preauthorized by the shared hospitality spaces;
generating, via the meal voucher generator, a list of host localized available meal vouchers from a plurality of meal vouchers associated with the booked shared hospitality space;
determining, via the food vendor location module, the geographical location of the food vendors associated with the list of generated meal vouchers;
denying, via the meal voucher generator, access to meal vouchers associated with the booked shared hospitality space if the geographical location of food vendor is further than a predefined radius from the shared hospitality space; and
displaying, via the meal voucher module, a subset of the list of host localized meal vouchers associated with the shared hospitality space on the electronic user device associated with the booking user.

2. The method of claim 1, wherein the step of generating a list of meal vouchers further comprises, determining, via the authorization module, the pre-approval of meal vouchers by the food vendors in association with the shared hospitality spaces.

3. The method of claim 1, wherein the step of generating a list of meal vouchers further comprises, generating, via the purchase module, a unique identification code for each meal voucher.

4. The method of claim 1, wherein the step of generating a list of meal vouchers further comprises, denying, via the meal voucher generator, access to the meal vouchers on dates which do not correspond to the booked dates of the shared hospitality space.

5. The method of claim 1, wherein the step of generating a list of meal vouchers further comprises, denying, via the meal voucher generator, access to the meal vouchers when not redeemed for delivery of food items or for dine-in.

6. A non-transitory computer readable storage medium having tangibly embodied thereon a program of instructions executable by a processor for generating host localized meal vouchers in a hospitality booking system, the system including one or more processors and a plurality of electronic user devices, the plurality of electronic user devices being remotely linked over a computer network through a network interface device configured to perform functions enabling communication to and from the computer network via a mobile or browser-based web application, a computer desktop application, an electronic module or subsystem of an online food ordering environment, a travel booking environment, a hotel reservation environment, a mobile environment, an electronic commerce system, an electronic payments system, a mobile application or an Internet-based website, each of the plurality of user computing devices including an electronic user interface and an electronic display, the one or more processors configured with one or more computer-implemented modules or generators including a meal voucher module, a validation module, an accommodation booking module, a meal voucher generator, a purchase module, a food vendor location module, a maps module, an authorization module, a user database, a food vendor database, a shared hospitality space database, instructions when executed causing the processor to perform steps of:
receiving, via the accommodation booking module, a host localized meal voucher generation request associated with a shared hospitality space booking request from an electronic device associated with at least one booking user, wherein the accommodation booking request comprises at least one date of accommodation, at least one check-in time, at least one check-out time and at least one geographical location;
determining, via the meal voucher module, a list of host localized available meal vouchers from a plurality of meal vouchers associated with the booked shared hospitality space, wherein the meal vouchers are preauthorized by the shared hospitality spaces;
generating, via the meal voucher generator, a list of host localized available meal vouchers from a plurality of meal vouchers associated with the booked shared hospitality space;
determining, via the food vendor location module, the geographical location of the food vendors associated with the list of generated meal vouchers;
denying, via the meal voucher generator, access to meal vouchers associated with the booked shared hospitality space if the geographical location of food vendor is further than a predefined radius from the shared hospitality space; and
displaying, via the meal voucher module, a subset of the list of host localized meal vouchers associated with the shared hospitality space on the electronic user device associated with the booking user.

7. The non-transitory computer readable storage medium of claim 6, wherein the step of generating a list of meal vouchers executed by instructions further comprises, determining, via the authorization module, the pre-approval of meal vouchers by the food vendors in association with the shared hospitality spaces.

8. The non-transitory computer readable storage medium of claim 6, wherein the step of generating a list of meal vouchers executed by instructions further comprises, generating, via the purchase module, a unique identification code for each meal voucher.

9. The non-transitory computer readable storage medium of claim 6, wherein the step of generating a list of meal vouchers executed by instructions further comprises, denying, via the meal voucher generator, access to the meal vouchers on dates which do not correspond to the booked dates of the shared hospitality space.

10. The non-transitory computer readable storage medium of claim 6, wherein the step of generating a list of meal vouchers executed by instructions further comprises, denying, via the meal voucher generator, access to the meal vouchers when not redeemed for delivery of food items or for dine-in.

11. An apparatus comprising:
a network interface configured for generating host localized meal vouchers in a hospitality booking system,
a processor coupled to the network interface,
a memory coupled to the processor, wherein the memory comprises instructions for execution on the processor to perform steps of:
receiving, via the accommodation booking module, a host localized meal voucher generation request associated with a shared hospitality space booking request from an electronic device associated with at least one booking user, wherein the accommodation booking request comprises at least one date of accommodation, at least one check-in time, at least one check-out time and at least one geographical location;
determining, via the meal voucher module, a list of host localized available meal vouchers from a plurality of meal vouchers associated with the booked shared hospitality space, wherein the meal vouchers are preauthorized by the shared hospitality spaces;
generating, via the meal voucher generator, a list of host localized available meal vouchers from a plurality of meal vouchers associated with the booked shared hospitality space;
determining, via the food vendor location module, the geographical location of the food vendors associated with the list of generated meal vouchers;
denying, via the meal voucher generator, access to meal vouchers associated with the booked shared hospitality space if the geographical location of food vendor is further than a predefined radius from the shared hospitality space; and
displaying, via the meal voucher module, a subset of the list of host localized meal vouchers associated with the shared hospitality space on the electronic user device associated with the booking user.

12. The apparatus of claim 11, wherein the step of generating a list of meal vouchers executed by instructions further comprises, determining, via the authorization module, the pre-approval of meal vouchers by the food vendors in association with the shared hospitality spaces.

13. The apparatus of claim 11, wherein the step of generating a list of meal vouchers executed by instructions further comprises, generating, via the purchase module, a unique identification code for each meal voucher.

14. The apparatus of claim 11, wherein the step of generating a list of meal vouchers executed by instructions further comprises, denying, via the meal voucher generator, access to the meal vouchers on dates which do not correspond to the booked dates of the shared hospitality space.

15. The apparatus of claim 11, wherein the step of generating a list of meal vouchers executed by instructions further comprises, denying, via the meal voucher generator, access to the meal vouchers when not redeemed for delivery of food items or for dine-in.
